(19) United States
(12) Patent Application Publication
(10) Pub. No.: US 2026/0339413 A1
(43) Pub. Date: Oct. 29, 2026

(54) VOLTAGE CONTROL METHOD AND COMPUTER SYSTEM

(71) Applicant: Lenovo Global Technology (Taiwan) Limited., Taipei (TW)

(72) Inventors: Sheng Wei CHENG, Taipei (TW); Shu-Te SU, Taipei (TW); Po Erh SHIH, Taipei (TW); Chih Wei WU, Taipei (TW)

(21) Appl. No.: 19/650,000

(22) Filed: Apr. 16, 2026

(30) Foreign Application Priority Data
Apr. 28, 2025 (CN) 202510545894.0

(51) Int. Cl. G06F 1/30; G06F 1/20; G06F 1/3206; G06F 1/3296

(52) U.S. Cl. CPC G06F 1/305; G06F 1/206; G06F 1/3206; G06F 1/3296; G06F 2200/201

(57) ABSTRACT

Embodiments of the present disclosure provide a voltage control method and a computer system, the voltage control method includes obtaining, by a baseboard management controller, an operating state of a system device; determining, by the baseboard management controller, a voltage ratio of a register in a voltage regulator based on the operating state, the voltage ratio is a value indicative of a proportional relationship between a reported supply voltage provided by the voltage regulator to the system device and an actual supply voltage; and adjusting, by the voltage regulator, the actual supply voltage of the system device based on the voltage ratio.

The present disclosure claims priority to Chinese Patent Application No. 202510545894.0, filed on Apr. 28, 2025, the entire content of which is incorporated herein by reference.

### FIELD OF TECHNOLOGY

Embodiments of the present disclosure relate to the field of computer technology, and relate to, but are not limited to, a voltage control method and a computer system.

### BACKGROUND

Data processing hardware such as a central processing unit (CPU, Central Processing Unit), a graphics processing unit (GPU, Graphics Processing Unit), a memory (Memory), and an accelerator chip has been undergoing iterative upgrades to meet higher data processing requirements.

In order to improve performance of the data processing hardware or support higher workloads, the data processing hardware often operates continuously at a higher voltage. A voltage regulator typically reports a false voltage value of the data processing hardware to a system, such that a reported voltage value is lower than an actual voltage supplied to the data processing hardware, thereby improving performance.

However, the voltage regulator is firmware, and modifying a reported voltage of the voltage regulator requires flashing, and therefore can only be performed when a system is restarted. As such, this approach cannot adapt to dynamic load use scenarios of a current computer system, and may cause an actual supplied voltage of the data processing hardware to mismatch an actual load demand, which may lead to problems in power supply stability, hardware reliability, and system availability.

### SUMMARY

In order to mitigate problems existing in related technologies, embodiments of the present disclosure provide a voltage control method and a computer system.

In a first aspect, the present disclosure provides a voltage control method, the voltage control method includes obtaining, by a baseboard management controller, an operating state of a system device; determining, by the baseboard management controller, a voltage ratio of a register in a voltage regulator based on the operating state, the voltage ratio is a value indicative of a proportional relationship between a reported supply voltage provided by the voltage regulator to the system device and an actual supply voltage; and adjusting, by the voltage regulator, the actual supply voltage of the system device based on the voltage ratio.

In a second aspect, embodiments of the present disclosure provide a computer system, the computer system includes: a baseboard management controller, configured to obtain an operating state of a system device in the computer system; the baseboard management controller is further configured to determine a voltage ratio of a register in a voltage regulator based on the operating state; the voltage ratio is a value indicative of a proportional relationship between a reported supply voltage provided by the voltage regulator to the system device and an actual supply voltage. The computer system father includes a voltage regulator, configured to adjust an actual supply voltage of the system device based on the voltage ratio.

The above description is only an overview of the technical solution of the present disclosure, and in order to more clearly understand the technical means of the present disclosure, the present disclosure may be implemented according to the contents of the specification, and in order to meet the above and other objectives, to realize features, and advantages of the present disclosure more apparent, specific embodiments of the present disclosure are provided below.

### BRIEF DESCRIPTION OF THE DRAWINGS

FIG. 1 is a first flowchart of a voltage control method provided by embodiments of the present disclosure.

FIG. 2 is a schematic structural diagram of a computer system provided by embodiments of the present disclosure.

FIG. 3 is a schematic diagram showing a correspondence between an under-reporting ratio and processor performance in related technologies.

FIG. 4 is a schematic diagram of operating states of a computer system provided by embodiments of the present disclosure.

FIG. 5 is a schematic structural diagram of a computer system provided by embodiments of the present disclosure.

### DETAILED DESCRIPTION

Embodiments of the present disclosure are described below in conjunction with the accompanying drawings in embodiments of the present disclosure. Some terms used in embodiments of the present disclosure are only used to explain specific embodiments of the present disclosure, and are not intended to limit the present disclosure. Those of ordinary skill in the art can know that, with the development of technology and the emergence of new scenarios, the technical solutions of embodiments of the present disclosure are also applicable to similar technical problems.

The terms “first” and “second” in the specification and claims of the present disclosure and in the above accompanying drawings are used to distinguish similar objects, and are not necessarily used to describe a specific order or sequence. The terms used in this way can be interchangeable under appropriate circumstances, which is only a manner of distinction adopted when describing objects with the same attributes in embodiments of the present disclosure. In addition, the terms “comprise,” “include,” and any variations thereof are intended to cover non-exclusive inclusion, so that a process, method, system, product, or device including a series of units is not limited to those units, but can include other units not expressly listed or inherent to such process, method, product, or device.

In the following description, reference is made to “some embodiments,” which describe a subset of all possible embodiments, but it should be understood that “some embodiments” may be the same subset or different subsets of all possible embodiments, and may be combined with each other without conflict. Unless otherwise defined, all technical and scientific terms used in embodiments of the present disclosure have the same meanings as commonly understood by a person skilled in the art to which embodiments of the present disclosure belong. The terms used in embodiments of the present disclosure are only for the purpose of describing embodiments of the present disclosure, and are not intended to limit the present disclosure.

In some embodiments, since the voltage regulator is firmware, modifying a reported voltage requires flashing, and can only be performed when a system is restarted. However, during operation, hardware load changes rapidly, and throttling events are easily triggered due to system health issues, for example, when the system detects a power abnormality (such as output voltage fluctuation or failure of a power supply unit (PSU, Power Supply Unit)), the voltage regulator may trigger throttling due to overcurrent or overtemperature protection mechanisms, limiting hardware load to maintain stability. This may cause a processing speed of data processing hardware to be significantly reduced, or even interrupt data processing tasks, thereby affecting applications in the computer system that have high real-time requirements.

Based on problems existing in related technologies, embodiments of the present disclosure can provide a voltage control method, a baseboard management controller obtains an operating state of a system device, the baseboard management controller determines a voltage ratio of a register in a voltage regulator based on the operating state, the voltage ratio is a value indicative of a proportional relationship between a reported supply voltage provided by the voltage regulator to the system device and an actual supply voltage, and the voltage regulator adjusts the actual supply voltage of the system device based on the voltage ratio. The voltage ratio is indicative of a relationship between reported power and actual power.

In this way, the baseboard management controller collects operating states such as current, temperature, and load of the system device in real time, and determines the actual supply voltage provided by the voltage regulator to the hardware device based on the operating state, thereby providing a voltage dynamic adjustment strategy during operation of the computer system, which can reduce problems in related technologies where, due to a fixed voltage ratio strategy, excessive power supply is provided when the computer system is idle causing waste, and insufficient power supply is provided when busy causing low performance, thereby achieving a balance between power consumption and performance; by using the method provided in embodiments of the present disclosure, the system can provide higher performance output as much as possible while consuming minimal power; meanwhile, when the voltage regulator adjusts the actual supply voltage, a system restart is not needed, implementation is simple, and service interruption of the computer system can be avoided, thereby improving system availability and reliability.

In embodiments of the present disclosure, the system device may be a central processing unit, a graphics processing unit, a general-purpose processor, a digital signal processor (DSP, Digital Signal Processor), or other programmable logic devices, discrete gates or transistor logic devices, discrete hardware components, storage devices, and other hardware in the computer system.

The technical solution of the present disclosure will be described in detail below with reference to the accompanying drawings.

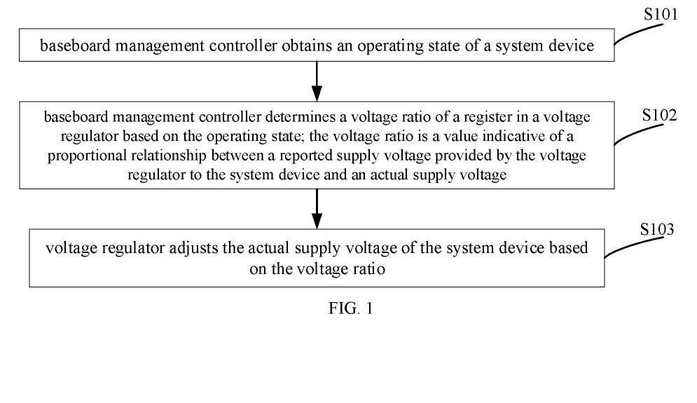

FIG. 1 is a first flowchart of a voltage control method provided by embodiments of the present disclosure. The voltage control method provided by embodiments of the present disclosure can be executed by a computer system, and the computer system at least includes a baseboard management controller and a voltage regulator. Here, the computer system may refer to an overall architecture in which hardware (such as a processor, a memory, a storage device, a power supply system, a management module, peripherals and interfaces), software (such as an operating system, drivers, and applications), firmware, and network components cooperate to implement computing functions.

As shown in FIG. 1, the voltage control method provided by embodiments of the present disclosure can be implemented through step S101 to step S103:

Step S101, a baseboard management controller obtains an operating state of a system device.

In embodiments of the present disclosure, the baseboard management controller (BMC, Baseboard Management Controller) is a controller in the computer system used for monitoring and managing hardware states and system health conditions of system devices in the computer system.

In some embodiments, the system device may refer to hardware devices such as a CPU, a GPU, a memory, and a Peripheral Component Interconnect Express (PCIe) device.

In some embodiments, the BMC, as a core component for hardware management in the computer system, can communicate with a host system (including system devices such as a CPU) through an enhanced serial peripheral interface (eSPI, Enhanced Serial Peripheral Interface), to implement real-time monitoring and management of operating states of the system device.

In some embodiments, the operating state may refer to a load state of the system device, for example, a no-load state, a light-load state, or a heavy-load state, wherein the no-load state may refer to that the system device does not carry any effective load and only maintains basic operation, with power being zero or close to zero; the light-load state may refer to that power of the system device is less than a thermal design power of the system device, that is, less than heat dissipation power required under a maximum load; the heavy-load state may refer to that power of the system device is greater than or equal to the thermal design power.

Step S102, the baseboard management controller determines a voltage ratio of a register in a voltage regulator based on the operating state; the voltage ratio is a value indicative of a proportional relationship between a reported supply voltage provided by the voltage regulator to the system device and an actual supply voltage.

In embodiments of the present disclosure, the voltage regulator (VR, Voltage Regulator) is programmable, and configuration parameters corresponding to the voltage regulator can be changed by modifying a value of the register, thereby enabling precise control of parameters such as an output voltage, a power consumption mode, and an operating frequency, and the voltage regulator can be operated through a specific register address.

Here, the voltage ratio may be indicative of a proportional relationship between a reported supply voltage provided by the voltage regulator to the system device and an actual supply voltage, wherein the reported supply voltage is a voltage value reported by the VR to a system (such as a BMC or an operating system) through a management interface (such as a power management bus (PMBus, Power Management Bus) or an integrated circuit (I2C, Integrated Circuit)), and the system determines a power supply state of the system device based on the reported supply voltage to trigger protection mechanisms (such as overvoltage frequency reduction and undervoltage alarm); and the actual supply voltage is an actual supply voltage actually output by the VR to the system device (such as a CPU or a GPU).

In some embodiments, the voltage ratio may also be indicative of a proportional relationship between a reported power and an actual power provided by the voltage regulator to the system device.

In embodiments of the present disclosure, a serial voltage identification communication mechanism (SVID, Serial Voltage Identification) may be provided between the voltage regulator (VR) and the system device, the mechanism being a cooperative working mechanism based on a serial protocol, and used for dynamically adjusting a voltage of the system device to adapt to different workloads and frequency requirements. When the system device operates, the system device sends a requested power value to the voltage regulator, that is, power needed for operation of the system device, and the voltage regulator provides an actual supply voltage to the system device based on the requested power value.

Here, the baseboard management controller can determine an actual operating power of the system under a current operating state according to the operating state of the system device, and the voltage ratio can be calculated based on the actual operating power and the requested power value, for example, the voltage ratio may be a difference between the requested power value and the actual operating power value.

In some embodiments, the voltage regulator is typically integrated with an integrated circuit (I2C, Integrated Circuit) interface or a serial peripheral interface (SPI, Serial Peripheral Interface), and after determining the voltage ratio of the register in the voltage regulator, the baseboard management controller can modify the voltage ratio in the register based on the I2C or SPI interface.

In some embodiments, the voltage ratio may be an under-reporting ratio or an over-reporting ratio of the voltage regulator, wherein when the reported supply voltage is less than the actual supply voltage, the voltage ratio is the under-reporting ratio, and when the reported supply voltage is greater than the actual supply voltage, the voltage ratio is the over-reporting ratio.

Step S103, the voltage regulator adjusts the actual supply voltage of the system device based on the voltage ratio.

The voltage regulator can obtain the actual supply voltage for supplying power to the system device based on the voltage ratio and the reported supply voltage, and the voltage regulator can supply power to the system device based on the actual supply voltage.

In embodiments of the present disclosure, the baseboard management controller collects operating states such as current, temperature, and load of the system device in real time, and determines the actual supply voltage provided by the voltage regulator to the hardware device based on the operating state, thereby providing a voltage dynamic adjustment strategy during operation of the computer system, which can reduce problems in related technologies where, due to a fixed voltage ratio strategy, excessive power supply is provided when the computer system is idle causing waste, and insufficient power supply is provided when busy causing low performance, thereby achieving a balance between power consumption and performance; by using the method provided in embodiments of the present disclosure, the system can provide higher performance output as much as possible while consuming minimal power; meanwhile, when the voltage regulator adjusts the actual supply voltage, a system restart is not needed, implementation is simple, and service interruption of the computer system can be avoided, thereby improving system availability and reliability.

In embodiments of the present disclosure, when the system device is in the first load state, that is, in a light-load state or a no-load state, the voltage regulation strategy is to cause the system device to be in an over-reporting state, the over-reporting state being indicative that an actual supply voltage is less than a reported supply voltage, that is, reducing the actual supply voltage provided by the voltage regulator to the system device, reducing resource waste, and enabling the computer system to operate in a more energy-efficient manner.

And step S2, in response to the system device being in the second load state, the voltage regulation strategy is to cause the system device to be in an under-reporting state, the under-reporting state being indicative that the actual supply voltage is greater than the reported supply voltage.

In some embodiments, when the system device is in the second load state, that is, in a heavy-load state, the voltage regulation strategy is to cause the system device to be in the under-reporting state, the under-reporting state being indicative that the actual supply voltage is greater than the reported supply voltage, that is, increasing the actual supply voltage provided by the voltage regulator to the system device, such that the system device operates in an overclocked manner, avoiding performance degradation of the system device, and ensuring that the computer system operates stably under a high load.

Step S1022, the voltage ratio is determined based on the voltage regulation strategy, the current operating power, and a requested power of the system device; wherein the requested power is indicative of a power value requested by the system device from the voltage regulator.

In embodiments of the present disclosure, the requested power value sent by the system device to the voltage regulator dynamically changes with an operating state (such as load intensity, operation type, frequency adjustment, or the like), and therefore, embodiments of the present disclosure dynamically adjust the voltage ratio such that the voltage regulator dynamically adjusts the actual supply voltage according to the operating state of the system device, so that the computer system can maintain a balance between performance and energy efficiency.

Here, the voltage control method provided by embodiments of the present disclosure can be performed when the requested power of the system device changes, and when the requested power changes, the baseboard management controller determines a current operating power of the system device based on the operating state, determines the voltage ratio based on the current operating power and the requested power, and modifies the voltage ratio in the register of the voltage regulator to a latest calculated voltage ratio.

In embodiments of the present disclosure, the baseboard management controller calculates a voltage ratio based on a real-time operating power and a requested power, and directly modifies parameters of a register of a voltage regulator, thereby avoiding a step in conventional control in which modifying the voltage ratio requires a system restart, reducing situations in which the computer system cannot provide services due to restart, and improving reliability of the computer system; and dynamically determining the voltage ratio can quickly match load requirements of the system device, reducing overheating or aging of the system device caused by long-term operation in a non-optimal voltage range, and improving a service life of the system device.

In some embodiments, the BMC continuously monitors a temperature of the system device, and if the temperature of the system device is sufficiently high (for example, exceeding 80°C), the BMC determines that the operating state of the system device is a high-load state; or if an actual supply voltage of the system device is sufficiently high (for example, a CPU supply voltage exceeding 1.4 V), the BMC also determines that the operating state of the system device is a high-load state, and therefore the voltage ratio may also be determined based on the temperature of the system device. The voltage control method provided in embodiments of the present disclosure may further include step S3 and step S4:

Step S3, in response to the system device being in the under-reporting state, the baseboard management controller obtains an operating temperature of the system device.

In some embodiments, if the system device is in the under-reporting state, that is, the system device continuously operates in a high-load state, the BMC may obtain the operating temperature of the system device, and adjust an actual supply voltage based on the temperature, to avoid damage to the system device caused by an excessively high temperature.

Step S4, in response to the operating temperature being greater than a temperature threshold, the baseboard management controller determines the voltage ratio based on the operating temperature.

In some embodiments, temperature thresholds of different system devices may be different, for example, a temperature threshold of a CPU may be 80°C, and when an operating temperature of the CPU is greater than 80°C, not only performance of the system device decreases, but also damage may be caused to the system device, and therefore, embodiments of the present disclosure may adjust the voltage ratio when the temperature of the system device exceeds the temperature threshold, and reduce an actual supply voltage of the system device to cool the system device.

In embodiments of the present disclosure, determining the voltage ratio based on the operating temperature may include determining the voltage ratio based on the operating temperature of the system device, the BMC obtains a current operating power of the system device, for example, a requested power sent by the system device to the voltage regulator is 300 W, the current operating power is 380 W, and a temperature is 81°C, at this time, the BMC needs to adjust the current operating power of the system device to 280 W to reduce the temperature of the system device, and at this time, the voltage ratio is 300/280 = 1.07.

In some embodiments, a test may be performed on the system device in advance to obtain a correspondence table between the operating temperature and the operating power, and when the operating temperature exceeds the temperature threshold, a target temperature may be determined by table lookup, for example, 70°C, and an operating power corresponding to 70°C is determined as an operating power to be adjusted, thereby determining the voltage ratio.

In embodiments of the present disclosure, after determining the voltage ratio, the BMC can modify the voltage ratio in the register of the voltage regulator, such that the voltage regulator supplies power based on the voltage ratio.

Correspondingly, step S103 may be implemented by step S1031:

Step S1031, the voltage regulator reduces the actual supply voltage of the system device based on the voltage ratio, to cause the system device to be in the over-reporting state.

In embodiments of the present disclosure, when the system device is in the under-reporting state, the voltage regulator reduces an actual supply voltage of the system device based on a modified voltage ratio, 1.07, to cause the system device to be in an over-reporting state.

In some embodiments, in order to prevent performance of the system device from decreasing excessively, the BMC may also not reduce a current operating power too much when determining the voltage ratio, for example, the current operating power may be reduced to 310, at this time, the voltage ratio is 0.97, and the voltage regulator reduces the actual supply voltage of the system device based on the modified voltage ratio 0.97, to cause the system device to remain in the under-reporting state, while reducing the temperature of the system device.

In embodiments of the present disclosure, when the system device operates in the under-reporting state, an operating temperature of the system device is monitored, and when the operating temperature exceeds a temperature threshold, the actual supply voltage is reduced, thereby reducing temperature while maintaining system hardware performance, ensuring hardware safety, extending a service life of the hardware, and avoiding service interruption caused by abrupt frequency changes through active voltage reduction, thereby improving stability and reliability of the computer system.

In some embodiments, the computer system may further include a cooling system, and when the system device is in the under-reporting state, the system device may be cooled to ensure system stability and prevent hardware damage. Therefore, the voltage control method provided in embodiments of the present disclosure may further include step S5:

Step S5, in response to the system device being in the under-reporting state, the baseboard management controller controls the cooling system to perform a cooling operation on the system device; wherein the cooling system includes an air cooling system and a liquid cooling system; the cooling operation includes at least one of: increasing a speed ratio of the air cooling system, increasing a flow rate of the liquid cooling system, and decreasing an inlet water temperature of the liquid cooling system.

In embodiments of the present disclosure, the cooling system includes an air cooling system and a liquid cooling system, the air cooling system may include heat sinks and fans, and the liquid cooling system may include a liquid cooling radiator.

When the system device is in the under-reporting state, the BMC can control an air cooling system and a liquid cooling system to cool the system device, so that an operating temperature of the system device is lower than a temperature threshold. Cooling may include increasing a speed ratio of the air cooling system, for example, increasing a speed ratio of a fan, herein, when the system device is in the under-reporting state, the speed ratio of the air cooling system may be greater than 1, and when the system device is in a normal state or an over-reporting state, the speed ratio of the air cooling system may be equal to 1.

In some embodiments, cooling may further include increasing a flow rate of the liquid cooling system and decreasing an inlet water temperature of the liquid cooling system, when the system device is in the under-reporting state, the liquid cooling system may be configured with a higher flow rate and a lower inlet water temperature; and when the system device is in the over-reporting state or a normal condition, a normal flow rate and inlet water temperature are used.

In embodiments of the present disclosure, the BMC performs a cooling operation on the system device in the under-reporting state through the cooling system, so that heat dissipation of the system device is more timely, preventing component aging caused by long-term high temperature, improving a service life of the system device, and also avoiding protective frequency reduction triggered by excessive temperature of the computer system, ensuring continuous and stable computing power output of the computer system, and improving system reliability.

In some embodiments, after the computer system is started, an operating state of the system device may be determined based on operating parameters of the system device in the computer system, and the voltage control method provided in embodiments of the present disclosure may further include step S11 to step S13:

Step S11, the baseboard management controller obtains operating parameters of the system device, the operating parameters at least include an operating voltage, an operating power consumption, and an operating temperature.

In embodiments of the present disclosure, the BMC may directly measure operating parameters such as the operating voltage, the operating temperature, and the operating power consumption of the system device through built-in or connected sensors, and may also obtain the operating parameters through a PMBus or I2C interface.

In embodiments of the present disclosure, the BMC may obtain operating parameters of the system device in real time, and may also obtain the operating parameters at preset time intervals (for example, every 30 s).

Step S12, the baseboard management controller compares the operating parameters with preset parameter thresholds to obtain a comparison result.

In embodiments of the present disclosure, in response to the operating parameter being an operating voltage, taking a CPU as an example, when the operating voltage is less than 0.98 V, the CPU may be considered to be in a light-load state, when the operating voltage is between 0.98 V and 1.3 V, the CPU is in a normal state, and when the operating voltage is greater than 1.3 V, the CPU may be considered to be in a heavy-load state.

In embodiments of the present disclosure, in response to the operating parameter being an operating temperature, taking a CPU as an example, when the operating temperature is less than 50°C, the CPU may be considered to be in a light-load state, when the operating temperature is between 50°C and 80°C, the CPU is in a normal state, and when the operating temperature is greater than 80°C, the CPU may be considered to be in a heavy-load state.

In embodiments of the present disclosure, in response to the operating parameter being an operating power consumption, taking a CPU as an example, when the operating power consumption is less than 50 W, the CPU may be considered to be in a light-load state, when the operating power consumption is between 50 W and 100 W, the CPU is in a normal state, and when the operating power consumption is greater than 100 W, the CPU may be considered to be in a heavy-load state.

Here, preset parameter thresholds of different system devices are different, and the above descriptions are only examples and do not constitute a limitation.

Step S13, the baseboard management controller determines the operating state of the system device based on the comparison result.

In embodiments of the present disclosure, the baseboard management controller determines the operating state of the system device based on a comparison result between operating parameters and preset parameter thresholds, and may adjust an actual supply voltage of the system device based on the operating state, thereby avoiding system crashes or performance degradation caused by hardware failures, implementing proactive maintenance of a hardware state of the system device, and providing assurance for efficient operation and maintenance and long-term stable operation of the computer system.

In some embodiments, the voltage control method provided in embodiments of the present disclosure may further include step S21 and step S22:

Step S21, the baseboard management controller obtains user behavior corresponding to the system device.

In some embodiments, obtaining user behavior corresponding to the system device by the baseboard management controller may include obtaining user behavior parameters related to user behavior, for example, a CPU load rate, when a user starts a large-scale game, the CPU load rate may rapidly exceed a preset maximum warning threshold (for example, 80%), at this time, the BMC acquires an event and determines that a current operating state of the CPU is a heavy-load state; it may also include that the BMC monitors CPU power consumption, memory usage, process states, and user operation logs to determine whether the user starts a high-computing task or a high-load task.

Step S22, the baseboard management controller performs behavior analysis on the user behavior to determine the operating state of the system device.

In embodiments of the present disclosure, the baseboard management controller may analyze CPU load rate, CPU power consumption, memory usage, process states, and user operation logs, when CPU utilization and memory usage are both at low levels (for example, a high CPU idle time ratio and sufficient free memory), and a user operation frequency is low and session requests are smooth, the BMC may determine that the operating state of the system device is a light-load state; if the CPU load rate or memory usage continuously exceeds preset thresholds for 5 minutes (for example, CPU peak ≥ 80%, memory usage ≥ 90%), or an average load is significantly higher than a number of CPU cores, the BMC may determine that the operating state of the system device is a light-load state.

In embodiments of the present disclosure, by analyzing user behavior corresponding to the system device to determine the operating state of the system device, it is possible to predict in advance that the system device will enter a high-load state, adjust an operating mode of the system device in advance or perform cooling in advance, effectively avoid system interruption, and enable operation to be more stable through pre-cooling.

In some embodiments, the voltage control method provided in embodiments of the present disclosure may further include step S31 and step S32:

Step S31, the baseboard management controller sends an adjustment request including the voltage ratio to the voltage regulator.

In embodiments of the present disclosure, after determining the voltage ratio, the baseboard management controller may send the adjustment request including the voltage ratio to the voltage regulator, so that the voltage regulator modifies the voltage ratio in a register, such that the voltage regulator adjusts an actual supply voltage based on the voltage ratio.

In some embodiments, step S31 may be implemented by step S311 or step S312:

Step S311, the baseboard management controller sends the adjustment request including the voltage ratio to the voltage regulator based on a field programmable gate array.

In embodiments of the present disclosure, the baseboard management controller may send the adjustment request to the voltage regulator through a hardware interface of a field programmable gate array (FPGA, Field Programmable Gate Array).

Step S312, the baseboard management controller sends the adjustment request including the voltage ratio to the voltage regulator based on an integrated circuit bus.

In embodiments of the present disclosure, the baseboard management controller may also directly send the adjustment request to the voltage regulator through the integrated circuit bus.

Step S32, the voltage regulator adjusts an initial voltage ratio in the register to the voltage ratio in response to the adjustment request.

In embodiments of the present disclosure, after receiving the adjustment request, the voltage regulator adjusts the initial voltage ratio in the register to the voltage ratio.

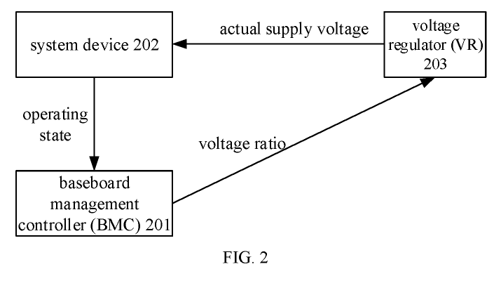

In embodiments of the present disclosure, a computer system is further provided. FIG. 2 is a schematic structural diagram of the computer system provided by embodiments of the present disclosure. As shown in FIG. 2, the computer system at least includes a baseboard management controller 201, a system device 202, and a voltage regulator 203, wherein the baseboard management controller 201 is configured to obtain an operating state of the system device in the computer system; the baseboard management controller 201 is further configured to determine a voltage ratio of a register in the voltage regulator based on the operating state; the voltage ratio is a value indicative of a proportional relationship between a reported supply voltage provided by the voltage regulator to the system device and an actual supply voltage; and the voltage regulator 203 is configured to adjust an actual supply voltage of the system device based on the voltage ratio.

In some embodiments, the baseboard management controller is further configured to determine a voltage regulation strategy and a current operating power of the system device based on the operating state; determine the voltage ratio based on the voltage regulation strategy, the current operating power, and a requested power of the system device; wherein the requested power is indicative of a power value requested by the system device from the voltage regulator.

In some embodiments, the operating state includes a first load state and a second load state, the first load state is indicative that the current operating power of the system device is less than a thermal design power of the system device; the second load state is indicative that the current operating power of the system device is greater than or equal to the thermal design power of the system device; the baseboard management controller is further configured to: in response to the system device being in the first load state, cause the system device to be in an over-reporting state, the over-reporting state being indicative that an actual supply voltage is less than a reported supply voltage; and in response to the system device being in the second load state, cause the system device to be in an under-reporting state, the under-reporting state being indicative that the actual supply voltage is greater than the reported supply voltage.

In some embodiments, the baseboard management controller is further configured to: in response to the system device being in the under-reporting state, obtain an operating temperature of the system device; and in response to the operating temperature being greater than a temperature threshold, determine the voltage ratio based on the operating temperature; correspondingly, the voltage regulator is further configured to reduce an actual supply voltage of the system device based on the voltage ratio, to cause the system device to be in the over-reporting state.

In some embodiments, the baseboard management controller is further configured to: in response to the system device being in the under-reporting state, control a cooling system to perform a cooling operation on the system device; wherein the cooling system includes an air cooling system and a liquid cooling system; and the cooling operation includes at least one of: increasing a speed ratio of the air cooling system, increasing a flow rate of the liquid cooling system, and decreasing an inlet water temperature of the liquid cooling system.

In some embodiments, the baseboard management controller is further configured to obtain operating parameters of the system device, the operating parameters at least include an operating voltage, an operating power consumption, and an operating temperature; compare the operating parameters with preset parameter thresholds to obtain a comparison result; and determine the operating state of the system device based on the comparison result.

In some embodiments, the baseboard management controller is further configured to obtain user behavior corresponding to the system device; and perform behavior analysis on the user behavior to determine the operating state of the system device.

In some embodiments, the baseboard management controller is further configured to send an adjustment request including the voltage ratio to the voltage regulator; and the voltage regulator is further configured, in response to the adjustment request, to adjust an initial voltage ratio in the register to the voltage ratio.

In some embodiments, the baseboard management controller is further configured to send the adjustment request including the voltage ratio to the voltage regulator based on a field programmable gate array; or to send the adjustment request including the voltage ratio to the voltage regulator based on an integrated circuit bus.

In embodiments of the present disclosure, the description of the computer system is similar to the description of the foregoing voltage control method, and has beneficial effects similar to those of the voltage control method, and therefore details are not described herein again. For technical details not disclosed in the embodiments of the computer system, reference may be made to the description of the voltage control method of the present disclosure for understanding.

Next, an application of the voltage control method in an actual scenario is provided.

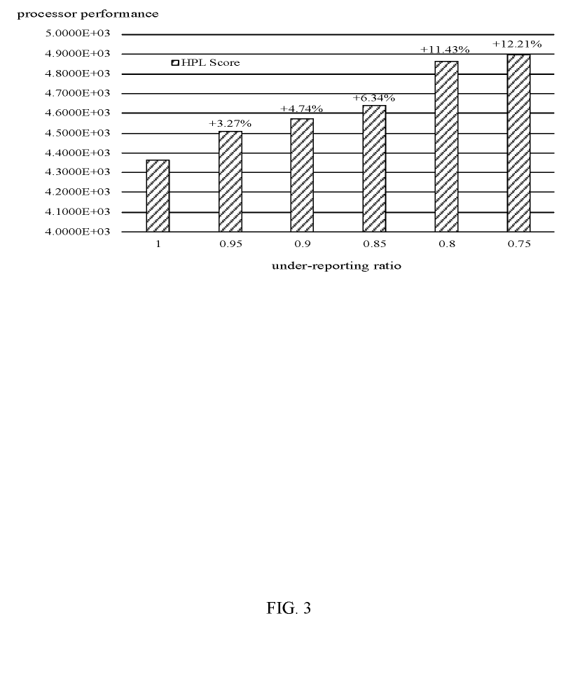

In a server field, in related technologies, a voltage regulator maximizes CPU performance through under-reporting, FIG. 3 is a schematic diagram showing a correspondence between an under-reporting ratio and processor performance in related technologies, as shown in FIG. 3, when the under-reporting ratio is 0.75 and 0.8, processor performance is improved the most.

Solutions in related technologies are easy to implement and can fully utilize existing power/thermal design schemes, however, when the under-reporting ratio changes in related technologies, the system needs to be restarted, and no state detection is performed on the computer system, and when an operating voltage of the computer system is too high, thermal trip occurs, or a fan or a PSU fails, throttling events are easily triggered.

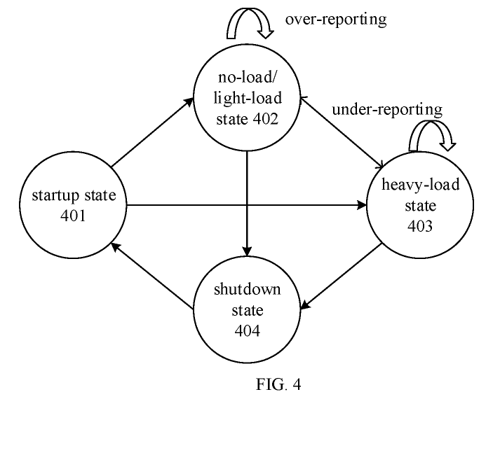

FIG. 4 is a schematic diagram of operating states of a computer system provided by embodiments of the present disclosure, as shown in FIG. 4, the computer system includes a startup state 401, a no-load/light-load state 402, a heavy-load state 403, and a shutdown state 404. After the computer system is started, the computer system may enter different operating states when executing different tasks, in the no-load/light-load state 402, the voltage regulator may perform over-reporting when reporting system states, and in the heavy-load state 403, the voltage regulator may perform under-reporting when reporting system states.

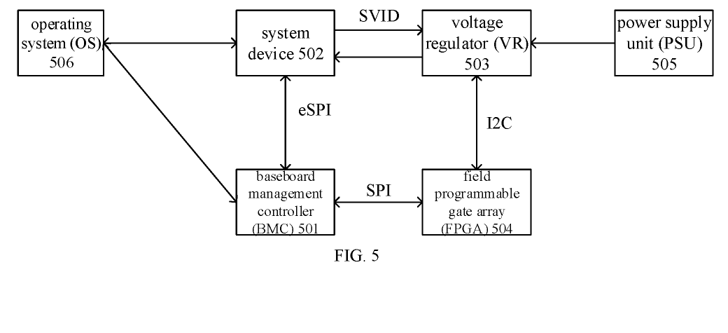

FIG. 5 is a schematic structural diagram of a computer system provided by embodiments of the present disclosure, as shown in FIG. 5, the computer system includes a baseboard management controller 501, a system device 502, a voltage regulator 503, a field programmable gate array 504, a power supply unit 505, and an operating system 506.

A serial voltage identification (SVID, Serial Voltage Identification) is a protocol used for communication between the system device 502 and the voltage regulator 503; an integrated circuit (I2C, Integrated Circuit) is a serial communication protocol used for communication between the field programmable gate array 504 and the voltage regulator 503.

The power supply unit (PSU, Power Supply Unit) 505 converts external alternating current into direct current required by components inside the computer system. The operating system (OS, Operating System) 506 is system software that manages and controls hardware and software resources of the computer system, serves as an interface between a user and hardware, coordinates resource allocation, and provides basic services.

The baseboard management controller 501 may determine user behavior based on the operating system 506, and determine an operating state of the system device 502 based on the user behavior. The baseboard management controller 501 may monitor data such as temperature, current, and voltage of the system device 502, and the baseboard management controller 501 may include an over-reporting/under-reporting control module, and perform over-reporting/under-reporting control on the system device 502 based on the temperature, current, and voltage of the system device 502.

In order to improve performance of the system device 502, the system device 502 is typically operated in an overclocked manner, when the system device 502 requests 300 W of power from the voltage regulator 503, the voltage regulator 503 provides 350 W of power to the system device 502, but the voltage regulator 503 reports to the system device 502 that only 300 W is provided, thereby implementing under-reporting, where reported power is lower than actual power, and at this time, an under-reporting ratio is 300/350 = 0.857.

The under-reporting ratio or the over-reporting ratio (that is, the voltage ratio) is written into a register of the voltage regulator 503, and embodiments of the present disclosure achieve state adjustment of the computer system by modifying the under-reporting ratio or the over-reporting ratio of the voltage regulator 503.

Embodiments of the present disclosure provide a dynamically adjustable under-reporting ratio or over-reporting ratio scheme, the baseboard management controller 501 issues an instruction to the field programmable gate array 504, and an I2C data link is provided between the field programmable gate array 504 and the voltage regulator 503. The baseboard management controller 501 may modify values of the over-reporting ratio and the under-reporting ratio in the voltage regulator 503 through the field programmable gate array 504.

After the computer system is started, if the system device 502 is in a light-load, light-load, or standby state, the baseboard management controller 501 controls the voltage regulator 503 to be in an over-reporting mode. When the system device 502 is in a high-load state, the baseboard management controller 501 controls the voltage regulator 503 to be in an under-reporting state.

After the computer system is started, the baseboard management controller 501 may determine whether the system device 502 is in a high-load state or a low-load state through two methods. A first method is to detect a power supply condition of the system device 502 (such as a CPU, a memory, or a PCIe device), if a supply level is very low (for example, 0.5 V), the baseboard management controller 501 determines that the system device 502 is in a no-load state or a low-load state, and notifies the field programmable gate array 504 to cause the voltage regulator 503 to be in an over-reporting state.

A second method is to detect user behavior or user operation characteristics, the baseboard management controller 501 obtains the user behavior through the operating system 506, when it is detected that a user performs a specific operation causing the system device 502 to enter a high-load state, for example, when the user starts a high-performance computing task or starts a large-scale game.

In some embodiments, if the high-load state of the system device 502 is determined based on a state of the system device 502, there may be a delay, if the system device 502 is already in the high-load state and then it is determined to be in the high-load state based on operating parameters and then adjustment is performed, there will be a delay, therefore, embodiments of the present disclosure may determine whether the system device 502 is about to enter the high-load state based on real-time user operations fed back by the operating system, and at this time, the baseboard management controller 501 may adjust the voltage regulator 503 to an under-reporting state through the field programmable gate array 504.

In embodiments of the present disclosure, if a temperature of the system device 502 exceeds a preset temperature threshold, or an actual supply voltage of the system device 502 is sufficiently high, for example, an actual supply voltage is 1.5 V, the baseboard management controller 501 also determines that the system device 502 is in a high-load state, and the baseboard management controller 501 may adjust the voltage regulator 503 to an over-reporting state through the field programmable gate array 504.

If the system device 502 continuously remains in the under-reporting state, that is, continuously operates in a high-load condition, the baseboard management controller 501 monitors the temperature of the system device 502 in real time, and if the temperature is about to exceed the temperature threshold, the baseboard management controller 501 may adjust the voltage regulator 503 to the over-reporting state through the field programmable gate array 504, to reduce voltage.

In embodiments of the present disclosure, in order to obtain higher performance, when the system device 502 is in the high-load state, the system device 502 may be cooled by an air cooling system and a liquid cooling system, for example, when in the under-reporting state, a fan speed ratio is greater than 1, and when in the over-reporting state or a normal state, the fan speed ratio is equal to 1, under the under-reporting state, the liquid cooling system adopts a higher flow rate and a lower inlet water temperature, and under the over-reporting state or a normal condition, the liquid cooling system adopts a normal flow rate and inlet water temperature.

In embodiments of the present disclosure, by using the voltage regulator, the computer system may operate under different system loads by adjusting the over-reporting ratio and the under-reporting ratio, thereby achieving maximum performance of the computer system at a cost of higher power consumption and lower energy efficiency.

The foregoing descriptions are only embodiments of the present disclosure, and are not intended to limit the scope of the present disclosure. Any modifications, equivalent substitutions, improvements, or the like made within the spirit and scope of the present disclosure shall be included within the scope of the present disclosure.

It should be understood that reference throughout the specification to “one embodiment” or “an embodiment” means that a particular feature, structure, or characteristic described in connection with the embodiment is included in at least one embodiment of the present disclosure. Thus, appearances of the phrases “in one embodiment” or “in an embodiment” in various places throughout the specification are not necessarily all referring to the same embodiment. Furthermore, the particular features, structures, or characteristics may be combined in any suitable manner in one or more embodiments. It should be understood that in various embodiments of the present disclosure, the sequence numbers of the processes described above do not imply an execution order, and the execution order of the processes should be determined based on their functions and internal logic, and should not constitute any limitation on an implementation process of embodiments of the present disclosure. The sequence numbers of the embodiments of the present disclosure are only for description and do not represent advantages or disadvantages of the embodiments.

It should be noted that, in this specification, the terms “include,” “including,” or any other variations thereof are intended to cover a non-exclusive inclusion, such that a process, method, article, or apparatus that includes a series of elements not only includes those elements but also includes other elements not expressly listed, or further includes elements inherent to such process, method, article, or apparatus. Without more limitations, an element defined by the phrase “including a …” does not exclude the presence of additional identical elements in the process, method, article, or apparatus that includes the element. In several embodiments provided in the present disclosure, it should be understood that the disclosed devices and methods may be implemented in other manners. The device embodiments described above are only illustrative, for example, division of units is only a logical functional division, and there may be other division manners in actual implementation, for example, multiple units or components may be combined, or may be integrated into another system, or some features may be omitted or not executed.

The foregoing descriptions are only implementations of the present disclosure, and the scope of the present disclosure is not limited thereto. Any changes or substitutions that can be readily conceived by a person skilled in the art within the technical scope disclosed in the present disclosure shall be covered by the scope of the present disclosure. Therefore, the scope of the present disclosure shall be subject to the scope of the claims.

What is claimed is:

1. A voltage control method, the voltage control method includes:
obtaining, by a baseboard management controller, an operating state of a system device;
determining, by the baseboard management controller, a voltage ratio of a register in a voltage regulator based on the operating state, the voltage ratio is a value indicative of a proportional relationship between a reported supply voltage provided by the voltage regulator to the system device and an actual supply voltage; and
adjusting, by the voltage regulator, the actual supply voltage of the system device based on the voltage ratio.

2. The voltage control method according to claim 1, wherein determining the voltage ratio of the register in the voltage regulator based on the operating state includes:
determining, by the baseboard management controller, a voltage regulation strategy and a current operating power of the system device based on the operating state;
determining the voltage ratio based on the voltage regulation strategy, the current operating power, and a requested power of the system device, wherein the requested power is indicative of a power value requested by the system device from the voltage regulator.

3. The voltage control method according to claim 2, wherein the operating state includes a first load state and a second load state, the first load state is indicative that the current operating power of the system device is less than a thermal design power of the system device; the second load state is indicative that the current operating power of the system device is greater than or equal to the thermal design power of the system device;
and determining, by the baseboard management controller, the voltage regulation strategy based on the operating state, including:
in response to the system device being in the first load state, causing the system device to be in an over-reporting state, the over-reporting state being indicative that an actual supply voltage is less than a reported supply voltage;
in response to the system device being in the second load state, causing the system device to be in an under-reporting state, the under-reporting state being indicative that the actual supply voltage is greater than the reported supply voltage.

4. The voltage control method according to claim 3, wherein the voltage control method further includes:
in response to the system device being in the under-reporting state, obtaining, by the baseboard management controller, an operating temperature of the system device;
in response to the operating temperature being greater than a temperature threshold, determining, by the baseboard management controller, the voltage ratio based on the operating temperature;
correspondingly, adjusting, by the voltage regulator, the actual supply voltage of the system device based on the voltage ratio, including that the voltage regulator reduces the actual supply voltage of the system device based on the voltage ratio, to cause the system device to be in the over-reporting state.

5. The voltage control method according to claim 4, wherein the voltage control method further includes:
in response to the system device being in the under-reporting state, controlling, by the baseboard management controller, a cooling system to perform a cooling operation on the system device;
wherein the cooling system includes an air cooling system and a liquid cooling system; the cooling operation includes at least one of: increasing a speed ratio of the air cooling system, increasing a flow rate of the liquid cooling system, and decreasing an inlet water temperature of the liquid cooling system.

6. The voltage control method according to claim 1, wherein the voltage control method further includes:
obtaining, by the baseboard management controller, operating parameters of the system device, the operating parameters at least include an operating voltage, an operating power consumption, and an operating temperature;
comparing, by the baseboard management controller, the operating parameters with preset parameter thresholds to obtain a comparison result;
determining, by the baseboard management controller, the operating state of the system device based on the comparison result.

7. The voltage control method according to claim 6, wherein the voltage control method further includes:
obtaining, by the baseboard management controller, user behavior corresponding to the system device;
performing, by the baseboard management controller, behavior analysis on the user behavior to determine the operating state of the system device.

8. The voltage control method according to claim 1, wherein the voltage control method further includes:
sending, by the baseboard management controller, an adjustment request including the voltage ratio to the voltage regulator;
adjusting, by the voltage regulator, in response to the adjustment request, an initial voltage ratio in the register to the voltage ratio.

9. The voltage control method according to claim 8, wherein sending the adjustment request including the voltage ratio to the voltage regulator includes:
sending the adjustment request including the voltage ratio to the voltage regulator based on a field programmable gate array; or
sending the adjustment request including the voltage ratio to the voltage regulator based on an integrated circuit bus.

10. A computer system, the computer system at least includes:
a baseboard management controller, configured to obtain an operating state of a system device in the computer system, and the baseboard management controller further configured to determine a voltage ratio of a register in a voltage regulator based on the operating state, the voltage ratio is a value indicative of a proportional relationship between a reported supply voltage provided by the voltage regulator to the system device and an actual supply voltage; and
a voltage regulator, configured to adjust an actual supply voltage of the system device based on the voltage ratio.

11. The computer system according to claim 10, wherein the baseboard management controller is further configured to determine a voltage regulation strategy and a current operating power of the system device based on the operating state, the voltage ratio is determined based on the voltage regulation strategy, the current operating power, and a requested power of the system device, and the requested power is indicative of a power value requested by the system device from the voltage regulator.

12. The computer system according to claim 11, wherein the operating state includes a first load state and a second load state, the first load state is indicative that the current operating power of the system device is less than a thermal design power of the system device; the second load state is indicative that the current operating power of the system device is greater than or equal to the thermal design power of the system device; and
the baseboard management controller is further configured to, in response to the system device being in the first load state, cause the system device to be in an over-reporting state, the over-reporting state being indicative that an actual supply voltage is less than a reported supply voltage, in response to the system device being in the second load state, cause the system device to be in an under-reporting state, the under-reporting state being indicative that the actual supply voltage is greater than the reported supply voltage.

13. The computer system according to claim 11, wherein:
in response to the system device being in the under-reporting state, the baseboard management controller is further configured to obtain an operating temperature of the system device; in response to the operating temperature being greater than a temperature threshold, the baseboard management controller is further configured to determine the voltage ratio based on the operating temperature; and
correspondingly, the voltage regulator is further configured to reduce the actual supply voltage of the system device based on the voltage ratio, to cause the system device to be in the over-reporting state.

14. The computer system according to claim 13, wherein the baseboard management controller is configured to:
in response to the system device being in the under-reporting state, control a cooling system to perform a cooling operation on the system device;
wherein the cooling system includes an air cooling system and a liquid cooling system; the cooling operation includes at least one of: increasing a speed ratio of the air cooling system, increasing a flow rate of the liquid cooling system, and decreasing an inlet water temperature of the liquid cooling system.

15. The computer system according to claim 10, wherein the baseboard management controller is configured to:
obtain operating parameters of the system device, the operating parameters at least include an operating voltage, an operating power consumption, and an operating temperature;
compare the operating parameters with preset parameter thresholds to obtain a comparison result; and
determine the operating state of the system device based on the comparison result.

16. The computer system according to claim 15, wherein the baseboard management controller is configured to obtain user behavior corresponding to the system device; and to perform behavior analysis on the user behavior to determine the operating state of the system device.

17. The computer system according to claim 10, wherein the baseboard management controller is further configured to send an adjustment request including the voltage ratio to the voltage regulator; and the voltage regulator is further configured to, in response to the adjustment request, adjust an initial voltage ratio in the register to the voltage ratio.

18. The computer system according to claim 17, wherein the baseboard management controller is further configured to:
send the adjustment request including the voltage ratio to the voltage regulator based on a field programmable gate array; or
send the adjustment request including the voltage ratio to the voltage regulator based on an integrated circuit bus.
